(19) United States
(12) Patent Application Publication
(10) Pub. No.: US 2013/0304933 A1
(43) Pub. Date: Nov. 14, 2013

(54) MULTI-NETWORK ENVIRONMENT ADAPTIVE MEDIA STREAMING TRANSMISSION METHOD AND APPARATUS

(71) Applicant: ELECTRONICS AND TELECOMMUNICATIONS RESEARCH INSTITUTE, Daejeon (KR)

(72) Inventors: Tae-Jung KIM, Cheongju-si (KR); Jae-Ho KIM, Daejeon (KR); Chang-Ki KIM, Daejeon (KR); Jeong-Ju YOO, Daejeon (KR); Jin-Woo HONG, Daejeon (KR)

(73) Assignee: Electronics and Telecommunications Research Institute, Daejeon (KR)

(21) Appl. No.: 13/804,324

(22) Filed: Mar. 14, 2013

(30) Foreign Application Priority Data
May 14, 2012 (KR) 10-2012-0050964

(51) Int. Cl. H04L 29/06

(52) U.S. Cl. CPC H04L 65/60
USPC 709/231

(57) ABSTRACT

A multi-network environment adaptive media streaming method and apparatus. The method of transmitting media streaming includes encoding content to generate media data consisting of a plurality of layers; separating the generated media data into layers; and transmitting the media data separated into layers to a media receiving apparatus in a streaming format over a plurality of networks.

### CROSS-REFERENCE TO RELATED APPLICATION(S)

This application claims the benefit under 35 U.S.C. §119(a) of Korean Patent Application No. 10-2012-0050964, filed on May 14, 2012, in the Korean Intellectual Property Office, the entire disclosure of which is incorporated herein by reference for all purposes.

### BACKGROUND

1. Field

The following description relates to broadcast communications, and more particularly, to media streaming transmissions that are adaptively optimized to a network environment.

2. Description of the Related Art

With the proliferation of diverse terminal devices, such as smartphones, tablet PCs, smart TVs, and the like, which are capable of Internet connection via wired/wireless networks, an increasing number of various multimedia services using the terminal devices have been available to users. Such multimedia services allow terminal devices' users to choose desired multimedia through the Internet and consume it at anytime, anywhere.

However, it may be difficult to guarantee a seamless provision of high-quality media streaming service through the Internet which does not ensure the quality of service. To address such drawbacks, hypertext transfer protocol (HTTP)-based adaptive streaming service has been introduced. The HTTP-based adaptive streaming service is to provide optimized media streaming services by means of a media transmitting apparatus that generates various channel environments and media sequences with different qualities depending on a terminal's specifications with respect to the same content, and a media receiving apparatus that receives media data over a designated channel according to its own environment and transmission channels.

Microsoft, Apple Inc., Adobe Systems Inc. and the like are representative companies that have been developing HTTP-based adaptive streaming technologies. Microsoft used Smooth Streaming for the live Internet broadcast of the 2008 Beijing Olympics, and Apple Inc. has applied HTTP live streaming technique to iPhone and iPad. Such techniques are classified as independent non-standard HTTP-based adaptive streaming services. To avoid the constraints imposed by the independent regulatory, MPEG has established standards for dynamic adaptive streaming over HTTP (hereinafter, referred to as “DASH”)

The introduction of DASH to Internet-based media streaming services allows a seamless provision of media data with a minimum quality, regardless of the channel bandwidth. For example, in the case of a narrow bandwidth of an IP network, video streams with low quality are is transmitted and, in the case of a wide bandwidth of an IP network, video streams with high quality are transmitted. Accordingly, video data encoded at a bit rate optimized to the transmission bandwidth of the IP network is transmitted, and thus the user can view a seamless image.

In addition, since DASH provides services with a quality variable with the channel conditions of a single IP network, the user cannot receive constant-quality media data. In other words, since DASH transmission is dependent on the bandwidth conditions of the IP network, it is not possible to always transmit high-quality image data. For example, if a bandwidth of an IP network of the user is narrow, it is not feasible to stream a high-definition image.

### SUMMARY

The following description relates to a multi-network environment-adaptive media streaming transmission method and apparatus for constantly providing a high-quality media streaming service to a user.

In one general aspect, there is provided a method of transmitting media streaming from a media transmitting apparatus, comprising: encoding content to generate media data consisting of a plurality of layers; separating the generated media data into layers; and transmitting the media data separated into layers to a media receiving apparatus in a streaming format over a plurality of networks.

In another general aspect, there is provided a media transmitting apparatus comprising: an encoding unit configured to encode content to generate media data consisting of a plurality of layers; a layer controlling unit configured to allocate layers for the encoding unit to perform encoding in accordance with a number of available network; a layer separating unit configured to separate the media data generated by the encoding unit into layers; and a media transmitting unit is configured to transmit the media data which have been separated into the layers to a media receiving apparatus in a streaming format over a plurality of networks.

In another general aspect, there is provided a method of receiving media streaming at a media receiving apparatus, comprising: receiving media data consisting of a plurality of layers generated by encoding content from a media transmitting apparatus over a plurality of networks; and decoding the received media data.

In further another general aspect, there is provided a media receiving apparatus comprising: a media receiving unit configured to receive media data from a media transmitting apparatus over a plurality of networks, wherein the media data consists of a plurality of layers generated by encoding content; and a decoding unit configured to decode the media data received by the media receiving unit.

Other features and aspects may be apparent from the following detailed description, the drawings, and the claims.

### BRIEF DESCRIPTION OF THE DRAWINGS

FIG. 1 is a diagram illustrating a multi-network-environment-adaptive media streaming transmission system according to an exemplary embodiment of the present invention.

FIG. 2 is a diagram illustrating in detail the media streaming transmission system shown in FIG. 1.

FIG. 3 is a diagram illustrating a media transmitting apparatus according to an exemplary embodiment of the present invention.

FIG. 4 is a diagram illustrating a media receiving apparatus according to an exemplary embodiment of the present invention.

FIG. 5 is a flowchart illustrating a method of a media transmitting apparatus to transmit media streaming according to an exemplary embodiment of the present invention.

FIG. 6 is a flowchart illustrating a method of a media receiving apparatus to receive media streaming according to an exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

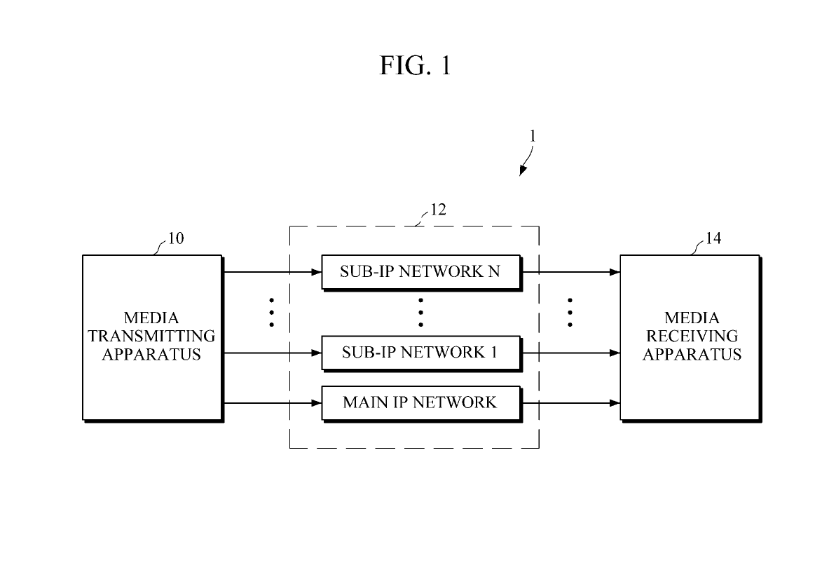

FIG. 1 is a diagram illustrating a multi-network-environment-adaptive media streaming transmission system according to an exemplary embodiment of the present invention. Referring to FIG. 1, a media streaming transmission system 1 includes a media transmitting apparatus 10, a network 12 composed of a plurality of IP networks, and a media receiving apparatus 14.

The media transmitting apparatus 10 transmits media data, for example, video data, to the media receiving apparatus 14 in a streaming format over the network 12 composed of multiple IP networks. The media receiving apparatus 14 accesses the network 12 to receive the media data in a streaming format.

The network 12 includes a plurality of IP networks which include a main IP network and sub-IP networks, as shown in FIG. 1. There may be present a number of sub-IP networks. The IP networks may be wired networks, such as 3G or 4G networks, wireless networks, such as WiFi networks, the Internet, IPTV networks, etc.

The media transmitting apparatus 10 provides the media receiving apparatus 14 with a media streaming service that is adaptively optimized to a multi-IP network environment. Accordingly, the media receiving apparatus 14 can be provided with a high-quality streaming service, regardless of transmission bandwidth of each IP network. To this end, the media transmitting apparatus 10 performs encoding on content on a layer-by-layer basis using scalable video coding (SVC), and transmits a plurality of encoded layers to the media receiving apparatus 14 over channels of the plurality of IP networks.

SVC, as scalable encoding extension of the H.264, was developed to solve problems, such as a low compression efficiency, inability to support combined scalability, and a high implementation complexity of the layer encoding-based scalability attempted by the conventional MPEG-2, MPEG-4, and the like. SVC encodes a number of video layers into a single bit stream, and the layers of SVC include a single base layer (BL) and a plurality of enhancement layers (ELs) that can be successively accumulated on the base layer. Each enhancement layer may represent a maximum bit rate, a frame rate, and even the resolution of each layer based on lower layer information. In the SVC, as more enhancement layers are successively accumulated, various bit rates, frame rates and resolutions can be supported, whereby a diversity problem regarding a bandwidth, a diversity problem regarding the performance and resolution of a receiver terminal, a diversity problem regarding the preference of the content's consumers, and the like, can be collectively solved. In this sense, the SVC is an is encoding technique suitable for a multimedia content service in a universal multimedia access (UMA) environment.

According to the present invention, the media transmitting apparatus 10 performs encoding on content on a layer-by-layer basis using SVC and generates a single bit stream formed by a number of encoded content layers. For example, if a video layer is formed with one basic layer and two enhancement layers, the media transmitting apparatus 10 may generate media data that forms one SVC bit stream that consists of three layers.

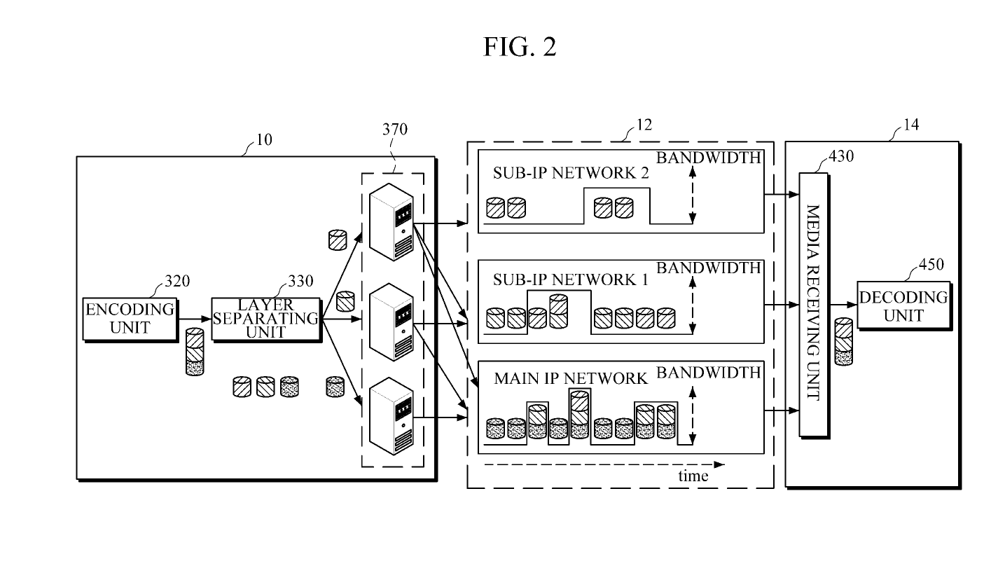

FIG. 2 is a diagram illustrating in detail the media streaming transmission system shown in FIG. 1. Referring to FIG. 2, a media streaming transmission system 1 has a multi-network-environment-adaptive streaming transmission structure based on SVC. More specifically, the media transmitting apparatus 10 includes an encoding unit 320 to encode content into a plurality of layers and generate media data using the encoded layers. The encoded media data forms a single SVC bit stream. If an available video layer consists of one base layer and two enhancement layers, as shown in FIG. 2, the encoding unit 320 generates media data that forms a single SVC bit stream consisting of three layers.

A layer separating unit 330 separates the media data generated by the encoded unit 320 into a number of layers and converts the separated layers into a transmission format. For example, the layer separating unit 330 separates the media data into one basic layer and two enhancement layers, as shown in FIG. 2. Thereafter, the media transmitting apparatus 10 stores the layers, which have been separated from the media data and converted into a transmission format, in corresponding dedicated folders 370, and then transmits the layers to the media receiving apparatus 14 over the network 12 consisting of a plurality of IP networks in a streaming format.

The media receiving apparatus 14 uses a media receiving unit 430 to receive the media is data transmitted from the media transmitting apparatus 10 over the network 12. The received media data is decoded by a decoding unit 450.

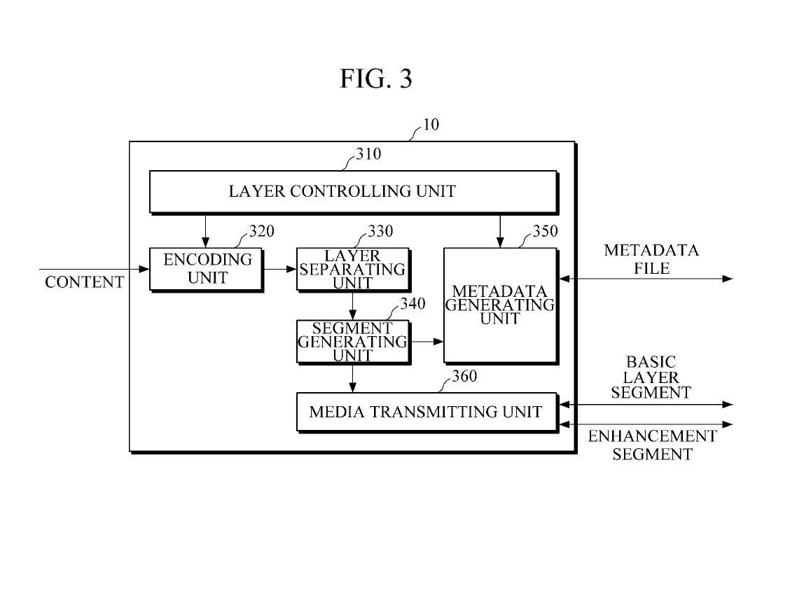

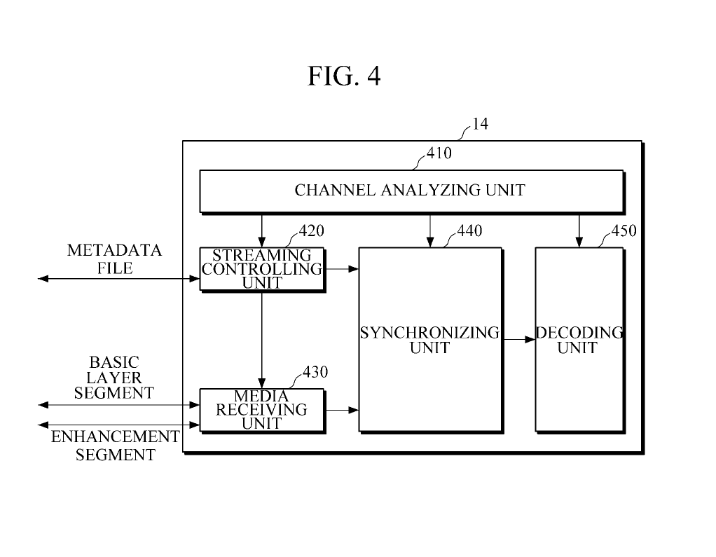

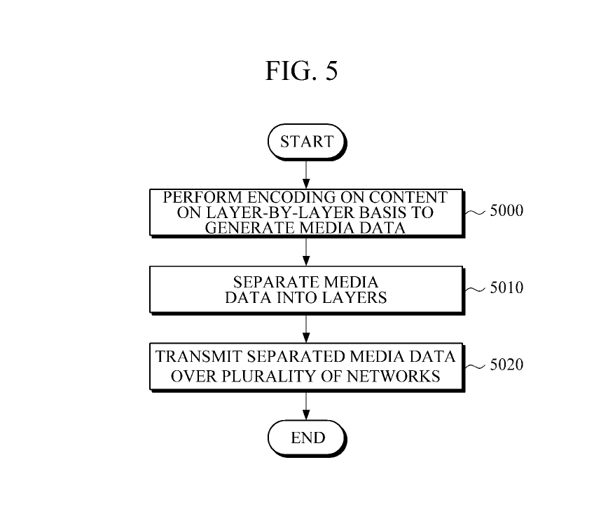

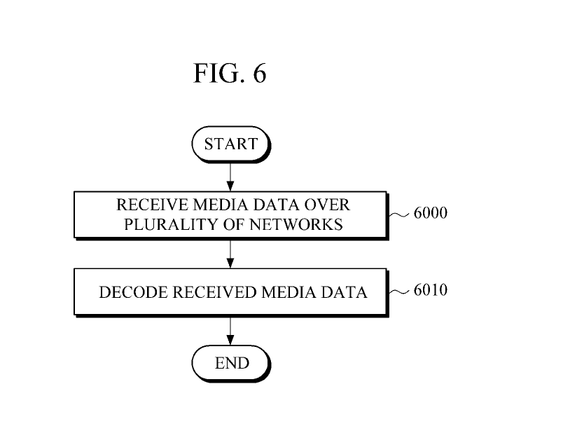

The media transmitting apparatus 10 and the media receiving apparatus 14 will now be described in detail with reference to FIGS. 3 and 4, and processes thereof will be described later with reference to FIGS. 5 and 6.

FIG. 3 is a diagram illustrating a media transmitting apparatus according to an exemplary embodiment of the present invention. Referring to FIGS. 1 and 3, the media transmitting apparatus 10 includes a layer controlling unit 310, an encoding unit 320, a layer separating unit 330, a segment generating unit 340, a metadata generating unit 350, and a media transmitting unit 360.

The layer controlling unit 310 allocates layers for the encoding unit 320 to perform encoding in accordance with the number of available networks. That is, the layer controlling unit 310 allocates SVC encoding layers to the encoding unit 320 according to the number of IP networks that are available to be provided by a provider. For example, if three heterogeneous IP network channels are available, the encoding unit 320 may encode content into one base layer and two enhancement layers.

The encoding unit 320 encodes content into a plurality of layers to create media data. At this time, the encoding unit 320 encodes the content into the same number of layers as the number of layers allocated by the layer controlling unit 310. Encoded binary data consists of one bit stream. The encoding unit 320 may be present at a video coding layer (VCL).

The layer separating unit 330 separates the media data into layers, wherein the media data is generated by the encoding unit 320. Specifically, the bit stream encoded by the encoding unit 320 is separated into layers by the layer separating unit 330. The separated layers of the media data are converted into a transmission format. The layer separating unit 330 may be present at a network abstraction layer (NAL).

The segment generating unit 340 divides the media data, which has been separated into layers and converted into a transmission format by the layer separating unit 330, into a number of segments. At this time, the segment generating unit 340 may divide the separated layers of media data on a time-unit basis (for example, in units of seconds). The generated segments may be stored in designated servers.

The metadata generating unit 350 generates metadata files associated with the respective layers separated from the media data which has been divided into a plurality of segments, and transmits the generated metadata files to the media receiving apparatus 14 over a number of networks. The number of metadata files generated by the metadata generating unit 350 may depend on the number of layers. For example, if the number of layers resulting from the encoding process by the encoding unit 320 is three, the metadata generating unit 350 may generate three metadata files. In other words, if there are three layers, it indicates that the provider can provide three heterogeneous IP network channels at most.

Each metadata file defines segmentation information and codec information, and presents access IP address, that is uniform resource locator (URL). The segment information and codec information may be acquired by the segment generating unit 340, and the URL information may be acquired by the layer controlling unit 310. If there are three layers, the metadata generating unit 350 generates one metadata file that presents URL of a main IP network and two metadata files that present URL of sub-IP networks, respectively. All metadata generated by the metadata generating unit 350 may be transmitted to the media receiving apparatus 14 when the media receiving apparatus 14 accesses a plurality of networks. The media receiving apparatus 14 may inevitably analyze the metadata associated with the main IP network, and, if necessary, may analyze the metadata associated with the sub-IP networks.

The media transmitting unit 360 transmits a plurality of segments that are created by the segment generating unit 340 by dividing the media data by the layer separating unit 330 to the media receiving apparatus 14 over the plurality of networks in a streaming format. The segments include a basic layer segment and enhancement layer segments.

In one example, the media transmitting unit 360 may primarily transmit the segments over the main IP network, and, if necessary, transmit the remaining segments over at least one sub-IP network. For example, the media transmitting unit 360 may primarily transmit the basic layer segment over the main IP network. At this time, if the main IP network is unstable and, for example, a channel bandwidth of the main IP network is not wide enough to allow all segments associated with all layers, only the segments associated with the layers allowable by the main IP network, including the base layer segment, may be primarily transmitted over the main IP network, and the remaining segments including the enhancement layer segments may be transmitted over the sub-IP networks.

FIG. 4 is a diagram illustrating a media receiving apparatus according to an exemplary embodiment of the present invention. Referring to FIGS. 1 and 4, the media receiving apparatus 14 includes a channel analyzing unit 410, a streaming controlling unit 420, a media receiving unit 430, a synchronizing unit 440, and a decoding unit 450.

The media receiving apparatus, as a client, accesses the network 12 including a plurality of IP networks to receive media data from the media transmitting apparatus 10 in a streaming format. The IP networks may include, for example, the Internet, an IPTV network, a wireless network, such as WiFi, and a wired network, such 3G or 4G network. The media receiving apparatus 14 dynamically adapts to the multi-IP network environment based on SVC and receives the media data in a streaming format, which is optimized to the network environment or a client environment. Hereinafter, the media receiving apparatus 14 characterized in the above-described aspects will be described in detail.

The channel analyzing unit 410 analyzes network states of the respective IP networks and provides the streaming controlling unit 420 with the network state information about available networks. At this point, the channel analyzing unit 410 may check available IP networks, monitor the network state, such as a bandwidth of each IP network, in real time, and provide the streaming controlling unit 420 with the network state information.

In response to the media transmitting apparatus 10 encoding content into a number of layers and generating metadata files associated with the respective layers, the streaming controlling unit 420 receives the metadata files from the media transmitting apparatus 10.

Then, the streaming controlling unit 20 decides at least one network which the media receiving apparatus 14 is to access based on the metadata files associated with the respective layers, which are received from the media transmitting apparatus, and the network state information received from the channel analyzing unit 410. In one example, the streaming controlling unit 420 identifies the number of metadata files and determines the number of IP networks accessible by the media receiving apparatus 14. Specifically, the streaming controlling unit 420 identifies HTTP-URL information of the segments from the metadata files. Then, the streaming controlling unit 420 determines whether to be provided with a streaming service over a plurality of IP networks or over a single IP network according to the IP network state information received from the channel analyzing unit 410.

The media receiving unit 430 receives a plurality of encoded segments from the media transmitting apparatus 10. The segments include a base layer segment and enhancement layer segments. The media receiving unit 430 opens all accessible HTTP links and receives the segments from the media transmitting apparatus 10 through an HTTP address allocated in response to an instruction of the streaming controlling unit 420. In one example, if a channel bandwidth of the main IP network is not wide enough to allow all layers, the media receiving unit 430 receives only the segments associated with layers that are allowable by the main IP network over the main IP network, and receives the remaining segments over other sub-IP networks.

The synchronizing unit 440 synchronizes the segments of the media data transmitted from the media transmitting apparatus 10 through the media receiving unit 430. At this time, the synchronizing unit 440 determines, based on video segment groups analyzed by the streaming controlling unit 420 and the network state information provided from the channel analyzing unit 410, how many layers are to be synchronized, and synchronizes the segments associated with the determined layers. In one example, the synchronizing unit 440 may identify layers of the received segments by checking the IP network state and the number of IP networks in use. If the number of IP networks and the number of the received layers are the same, the synchronizing unit 440 may perform synchronization using a timestamp value.

The decoding unit 450 receives the segments synchronized by the synchronizing unit 440 and converts their transmission format into a video format. Then, the decoding unit 450 decodes the segments which have been converted into a video format.

FIG. 5 is a flowchart illustrating a method of a media transmitting apparatus to transmit media streaming according to an exemplary embodiment of the present invention.

Referring to FIG. 5 in conjunction with FIG. 2, the media transmitting apparatus 10 encodes content into a number of layers to generate media data in 5000, and separates the generated media data into layers in 5010. In one example, in 5000, the media transmitting apparatus 10 may perform encoding on the content on a layer-by-layer basis, and generates media data that forms a single bit stream consisting of as many layers as layers resulting from the encoding process. In addition, in 5010, the media data constituting the single bit stream is separated into a base layer and enhancement layers.

The media transmitting apparatus 10 transmits segments, which are created by dividing the media data that has been separated into layers, to the media receiving apparatus 14 in a streaming format over a plurality of networks in 5020.

In one example, in 5020, the media transmitting apparatus 10 converts the media data which has been separated into layers into a transmission format, divides the converted media data into segments, and transmits the segmented media data to the media receiving apparatus 14 over a plurality of networks. At this point, the media transmitting apparatus 10 may store the segments, respectively, into corresponding designated folders, primarily transmit some segments over a main IP network, and, if necessary, transmit the remaining segments over at least one sub-IP network.

In one example, in 5020, the media transmitting apparatus 10 generates metadata files for the respective layers of the separated media data, and transmits the metadata files for the respective layers to the media receiving apparatus 14 over the plurality of IP networks. The metadata files include at least one of segmentation information, codec information and access IP address information.

FIG. 6 is a flowchart illustrating a method of a media receiving apparatus to receive media streaming according to an exemplary embodiment of the present invention.

Referring to FIG. 6 in conjunction with FIG. 2, the media receiving apparatus 14 receives media data from the media transmitting apparatus 10 over a network consisting of a plurality of IP networks, wherein the media data is generated by performing encoding on content on a layer-by-layer basis in 6000. Then, the media receiving apparatus 14 decodes the received media data in 6010.

In one example, the media receiving apparatus 14 receives metadata files which have been generated for the respective layers of the media data after the encoding process from the media transmitting apparatus 10. Then, based on the received metadata files, the media receiving apparatus 14 determines an IP network to access. In this case, in 6000, the media receiving apparatus 14 accesses the determined network and receives the media data from the media transmitting apparatus 10.

The media data received from the media transmitting apparatus 10 consists of segments that are created by dividing media data generated by encoding content into a plurality of layers. In one example, in 6000, the media receiving apparatus 14 primarily receives only the segments associated with layers that are allowable by a main IP network over the main IP network. In addition, when it fails to receive all segments over the main IP network, the media receiving apparatus 14 receives the remaining segments over at least one sub-IP network.

In one example, in 6010, the media receiving apparatus 14 synchronizes the segments of the media data received from the media transmitting apparatus 10 over a plurality of IP networks, and decodes the synchronized segments. At this time, the number of segments to be synchronized is determined based on layer information and network state information, and the determined number of segments are synchronized with each other.

As described above, the present invention overcomes drawbacks of an existing network-environment adaptive streaming scheme that provides a low-quality media service due to a bandwidth limitation of a single network channel so that it is possible to implement media streaming transmission that is adaptively optimized to a multi-network environment and thus to provide high-quality media streaming services.

Specifically, an existing advanced video coding (AVC)-based environment-adaptive streaming scheme uses a single IP network when providing media streaming services. However, according to the exemplary embodiments of the present invention, it is possible to implement streaming transmission of high-quality media data over a plurality of IP networks by performing encoding on content on a layer-by-layer basis using SVC and separating layers from generated media data.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of transmitting media streaming from a media transmitting apparatus, comprising:
encoding content to generate media data consisting of a plurality of layers;
separating the generated media data into layers; and
transmitting the media data separated into layers to a media receiving apparatus in a streaming format over a plurality of networks.

2. The method of claim 1, wherein
the generating of the media data comprises encoding the content into a number of layers and generating the media data constituting a single bit stream that consists of the same number of layers as the encoded layers and
the separating of the generated media into the layers comprises separating the is media data constituting the single bit stream into a base layer and one or more enhancement layers.

3. The method of claim 1, wherein the transmitting of the media data in a streaming format comprises converting the media data which has been separated into the layers into a transmission format, dividing the media data converted into the transmission format into a plurality of segments, and transmitting the segments of the media data over the plurality of networks.

4. The method of claim 3, wherein the transmitting of the segments of the media data over the plurality of networks comprises storing the segments in corresponding designated folders and transmitting some of the stored segments primarily over a main IP network and, if necessary, transmitting the remaining segments over at least one sub-IP network.

5. The method of claim 1, wherein the transmitting of the media data in a streaming format comprises generating metadata files associated with the respective layers separated from the media data, and transmitting the generated metadata files over the plurality of networks.

6. The method of claim 5, wherein the metadata files include at least one of segmentation information, codec information and access IP address information.

7. A media transmitting apparatus comprising:
is an encoding unit configured to encode content to generate media data consisting of a plurality of layers;
a layer controlling unit configured to allocate layers for the encoding unit to perform encoding in accordance with a number of available network;
a layer separating unit configured to separate the media data generated by the encoding unit into layers; and
a media transmitting unit configured to transmit the media data which have been separated into the layers to a media receiving apparatus in a streaming format over a plurality of networks.

8. The media transmitting apparatus of claim 7, further comprising:
a segment generating unit configured to divide the media data, which have been separated into the layers by the layer separating unit, into segments,
wherein the media transmitting unit is configured to transmit the segments divided from the media data over the plurality of networks.

9. The media transmitting apparatus of claim 8, further comprising:
a storage unit configured to store the segments divided from the media data,
wherein the media transmitting unit is configured to transmit some of the stored segments primarily over a main IP network and, if necessary, transmit the remaining segments over at least one sub-IP network.

10. The media transmitting apparatus of claim 8, further comprising:
a metadata generating unit configured to generate metadata files associated with the respective layers separated from the media data which has been divided into segments by the segment generating unit and to transmit the generated metadata files over the plurality of networks.

11. A method of receiving media streaming at a media receiving apparatus, comprising:
receiving media data consisting of a plurality of layers generated by encoding content from a media transmitting apparatus over a plurality of networks; and
decoding the received media data.

12. The method of claim 11, further comprising:
receiving metadata files generated in association with the respective layers of the generated media data from the media transmitting apparatus;
determining, based on the received metadata files associated with the respective layers, at least one network for the media receiving apparatus to access,
wherein the receiving of the media data over the plurality of networks comprises accessing the at least one determined network to receive the media data from the media transmitting apparatus.

13. The method of claim 12, wherein the determining of the at least one network for the media receiving apparatus to access comprises determining a number of networks accessible by the media receiving apparatus by identifying a number of the metadata files received from the media transmitting apparatus and determining the at least one network for the media receiving apparatus to access from among the accessible networks based on network state information of networks identified from access internet protocol (IP) address information included in the metadata files.

14. The method of claim 11, wherein the media data received from the media transmitting apparatus consists of segments divided from the media data, which have been generated by encoding content into a plurality of layers, and the receiving of the media data over the plurality of networks comprises receiving primarily only segments associated with layers allowable by a main IP network over the main IP network, and if it fails to receive all segments over the main IP network, receiving the remaining segments over at least one sub-IP network.

15. The method of claim 11, wherein the decoding of the received media data comprises synchronizing the segments of the media data received from the media transmitting apparatus over the plurality of networks and decoding the synchronized segments.

16. The method of claim 15, wherein the synchronizing of the received segments of the media data comprises determining, based on layer information and network state information, a number of segments to be synchronized, and synchronizing the determined number of segments.

17. A media receiving apparatus comprising:
a media receiving unit configured to receive media data from a media transmitting apparatus over a plurality of networks, wherein the media data consists of a plurality of layers generated by encoding content; and
a decoding unit configured to decode the media data received by the media receiving unit.

18. The media receiving apparatus of claim 17, further comprising:
a streaming controlling unit configured to receive metadata files generated in association with the respective layers of the media data from the media transmitting apparatus and to determine, based on the received metadata files and network state information, at least one network for the media receiving apparatus to access,
wherein the media receiving unit is configured to receive the media data from the media transmitting apparatus over the at least one determined network.

19. The media receiving apparatus of claim 18, further comprising:
a channel analyzing unit configured to analyze states of the respective networks and provide the streaming controlling unit with network state information about available networks.

20. The media receiving apparatus of claim 17, further comprising:
a synchronizing unit configured to segments of the media data received from the media transmitting apparatus over the plurality of networks.
